(19) United States
(12) Patent Application Publication
(10) Pub. No.: US 2003/0214939 A1
(43) Pub. Date: Nov. 20, 2003

(54) Method and apparatus for providing life line service to access gateway telephony subscribers

(76) Inventors: Ismail I. Eldumiati, Irvine, CA (US); Charles F. Raasch, Lake Forest, CA (US); Carlos A. Laiz, Costa Mesa, CA (US); Joel D. Peshkin, San Juan Capistrano, CA (US)

Correspondence Address: Jack J'maev, 12616 LEWIS AVE, CHINO, CA, 91710, US

(21) Appl. No.: 10/147,031

(22) Filed: May 15, 2002

(51) Int. Cl. H04L 12/66

(52) U.S. Cl. 370/352; 370/400

(57) ABSTRACT

Lifeline services ensured to local access gateway telephony users by connection of local telephone string to central office and bypassing failed gateway or digital channel. Central office provides PSTN service to local telephone string allowing phone service to continue. Dual-function phones provide digital and analog capability ensuring lifeline service.

### FIELD OF THE INVENTION

This invention relates generally to integrated data and telephone systems and specifically to provision of lifeline services to subscribers using such systems.

### BACKGROUND OF THE INVENTION

“Mr. Watson. Come Here. I want you.” The very first words ever communicated by telephone turned out to be a distress signal. Modernly, citizens of developed nations around the globe enjoy the peace of mind that comes with knowing that help can be summoned almost immediately using the telephone. In an emergency, the telephone has proven to be a reliable way to call for police, fire or medical assistance.

Today, it is simply unthinkable that the telephone could not be used in an emergency situation. Most people know that their telephones will continue to operate even if local utility power is lost. Most people also know that their telephones will continue to operate even in the wake of a major catastrophe. Our society most likely takes for granted the painstaking efforts undertaken by telephone companies to ensure such high levels of service availability. The rudimentary capability to call for help has come to be known as basic lifeline telephone service.

In the modern world, the need for communication is almost insatiable. Even in a simple domestic setting, there is suddenly the need for more than one telephone line. Because computer networking has become so pervasive, domestic users now demand high-speed network connectivity. All of this demand for communication has spawned major rethought with respect to the telephone infrastructure.

Telephone subscribers in the residential setting now typically use at least two telephone lines: one for traditional voice communications and one typically for facsimile, or other voice band data communications functions. In many residential settings, additional telephone lines are required to service home-based businesses or telecommuting offices. Small businesses also need several voice lines, one for facsimile, and access to high-speed networking. From this perspective the communication needs of a home or a small business are quite similar.

In most circumstances, the physical connectivity from a residence or a small business to the central telephone office may be limited. In many cases, only a single physical medium may exist between the two points. One way of providing additional communication service to a home or small business would be to add additional physical medium between the subscriber's premises and the central office. Of course, this requires “pulling” additional cable through an already crowded infrastructure.

The modern alternative to more cable is based on the use of digital communications between the central office and the subscriber facility. A communication access gateway may typically be deployed at a subscriber's facility and connected to the central office using digital communication techniques. In many instances, the digital communications channel between central office and subscriber is in the form of a digital subscriber line (DSL). Where traditional voice telephony uses only a few kilohertz of bandwidth, a digital communications channel in this type of installation is capable of exploiting most, if not all of the bandwidth the existing medium can support.

From within the subscriber's facility, the access gateway communicates with the central office using digital data packets. Some of these data packets may be used for traditional voice communications. Other data packets may be used to carry network data. The access gateway typically provides at least one data networking port and one local telephone port. In some systems, these ports can be switched from voice to data on demand. In application, the home or small business user would connect their local area network to the data networking port provided by the access gateway. The local telephone port would typically be connected to a local telephone string. In operation, the access gateway serves as a networking switch that propagates network data from the local area network back to the central office. Likewise, voice telephony from the local telephone string is converted to digital data packets so that it too may be communicated back to the central office.

One problem with the use of such access gateways is the fact that the access gateway must be operational to support voice telephony. In some emergency situations, or where the access gateway experiences a general failure, telephone instruments attached to the local telephone string that is connected to the gateway would be inoperable. This means that emergency lifeline telephone service would be unavailable. This is certainly an ironic twist in a time of ever-expanding communications capability demanded by, and provided to domestic and small business telephone subscribers.

In those subscriber facilities that gain access to voice telephony through an access gateway, lost utility power would be one circumstance in which lifeline telephone service would be unavailable. Of course, any failure in the digital communications channel between the subscriber facility and the telephone service infrastructure would preclude lifeline service. This results in a very unfavorable position for any person needing emergency services when any of these types of failures occur. What is needed, then, is a method to provide lifeline telephone service in those situations where the access gateway or the digital communications channel servicing that gateway has become unavailable.

### SUMMARY OF THE INVENTION

The present invention comprises a method for providing lifeline services to subscriber facilities that use a local access gateway for their primary telephone service. Normally, a facility that uses a local access gateway for telephone service disposes the access gateway between a local telephone string installed at the subscriber's facility and a telephone company central office. Telephone instruments are typically attached to the local telephone string.

The access gateway will ordinarily provide either public switched telephone network (PSTN) or digital telephone service to telephone instruments attached to the local telephone string. In some embodiments, the telephone instruments attached to the local telephone string are traditional analog POTS (plain old telephone service) telephones. The access gateway may comprise a telephone coder/decoder CODEC that converts analog telephony signals from the local telephone string into digital data packets. The digital data packets may then be conveyed to the telephone company central office using a digital communications channel.

In one example embodiment of a method according to the present invention, the local POTS string may be connected directly to the central office when there is a failure in the access gateway or some other impairment of the digital communications channel that allows the access gateway to communicate with central office. In this event, the central office may begin providing PSTN telephone service to the local string in order to continue telephone service during the failure interval.

The method of the present invention teaches several means for communicating the existence of an anomalous condition back to the central office. In one illustrative embodiment of this method, a health signal may be injected into the carrier loop that comprises the physical medium between the subscriber's facility and the central office. A health signal may also be conveyed to the central office using higher levels of communications protocols.

The central office may monitor the carrier loop, and upon detecting that the health signal is no longer present may begin providing PSTN service to the carrier loop. In another example embodiment, an anomalous condition may be detected by monitoring the health of the access gateway. Whenever the health of the access gateway becomes degraded, the central office may then provide PSTN to the local telephone string. By providing PSTN service to the local telephone string, the central office provides the power and control necessary to support operation of analog telephone instruments attached to the local telephone string.

In one variation of the example method taught here, the central office may determine when to provide PSTN service by monitoring the quality of the digital communications service between the access gateway and the central office. In the event that the quality of digital service falls below that necessary to support digital telephony at the subscriber's facility, the central office may provide PSTN service to the local telephone string to ensure continued availability of lifeline service.

In yet another illustrative method, the central office may provide PSTN service to the local telephone string when it becomes apparent that the subscriber's facility is about to lose utility power. In this event, the central office supports lifeline service when the access gateway is not operating.

Some subscriber facilities use digital telephone instruments. These are typically attached to the local telephone string. In these types of system installations, the local telephone string may operate in a digital mode. These digital telephone instruments are typically used in systems that provide advanced telephone function. In some cases, the digital telephone instruments may not prove reliable in exigent circumstances. Hence, the method of the present invention may further comprise the steps of disassociating the full-featured phone functionality from the local telephone string and enabling POTS functionality so that traditional analog telephony may be provided.

The present invention also comprises a system that supports lifeline service in those situations where a subscriber facility gains access to telephone service through an access gateway. The system of the present invention implements the methods described henceforth. Accordingly, the system comprises an access gateway that comprises a local biasing unit that ordinarily provides power and control to a local telephone string. This biasing unit may operate in either PSTN or digital modes. The system further comprises a failure detection unit that monitors the operational status of the access gateway, the fidelity of the digital communications channel used by the access gateway to communicate with the central office, or both. When a failure is detected, the failure detection unit generates a crossover signal. In some embodiments, the failure detection unit generates a health signal. In these embodiments, crossover is affected when the health signal is no longer active.

The system further comprises a crossover connection unit. When the crossover signal generated by the failure detection unit becomes active, the crossover connection unit connects the local telephone string to the central office. The system may further comprise a central office subscriber unit (COSU) that may provide PSTN service to the local telephone string in the event of a detected failure. In some embodiments of this system, the central office may continually provide PSTN service to the medium used to connect the central office to the subscriber's facility. In these cases, the local telephone string may only need to be connected to the central office and the COSU may not need to respond to the crossover signal.

In one alternative embodiment of a system according to the present invention, the failure detection unit may monitor the fidelity of the digital communications channel servicing the access gateway. Fidelity may be inferred by monitoring the activity of a digital subscriber line access multiplexer that may be servicing the local access gateway. In these embodiments, the crossover signal may be generated when the digital subscriber line access multiplexer becomes inactive. In an alternative system embodiment, the failure detection unit may deactivate the crossover signal when the digital subscriber line access multiplexer becomes active again. Because the digital subscriber line access multiplexer is typically disposed at the central office, the COSU may determine when to provide PSTN service to the local telephone string without any active interaction with the subscriber's facility. In this embodiment of the present invention, the COSU may use the same access number to connect to a telephone switching network typically comprising a TDM network.

In one illustrative embodiment of a system according to the present invention, the crossover signal generated by the failure detector may be conveyed to the central office by injecting a signal into the carrier loop that connects the central office to the subscriber's facility. In some embodiments, the failure detection unit may generate the crossover signal when it becomes apparent that the subscriber's facility is about to lose utility power. In yet another illustrative embodiment, the crossover connection unit may connect the local telephone string to the central office if local facility power is lost. In some embodiments of the present invention, the crossover unit may comprise a relay wired to connect the local telephone string to the central office when the relay's coil is not energized.

In yet another illustrative embodiment of the invention, the system comprises a dual-function telephone. In some access gateway based system installations, digital telephone instruments are disposed in the user's facility. These digital telephone instruments are typically connected to the local telephone string and may not be capable of providing lifeline service when the access gateway or any part of the digital communications path to the central office is lost. In order to ensure lifeline service is provided in such a circumstance, the dual-function telephone instrument comprises a digital telephone circuit, an analog telephone circuit and an isolation unit. In operation, the isolation unit disassociates the digital phone circuit from the local telephone string and connects the analog circuit in its place.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The foregoing aspects are better understood from the following detailed description of one embodiment of the invention with reference to the drawings, in which:

FIG. 1 is a block diagram of a communications system comprising an access gateway that provides data and voice communications to a facility;

FIG. 2 is a flow diagram that depicts one illustrative method for providing lifeline telephone service to a facility having telephony capabilities provided by an access gateway;

FIG. 3 is a flow diagram that depicts one illustrative method for enabling a central office to provide PSTN service to a subscriber's facility in support of lifeline service according to the present invention;

FIG. 4 is a block diagram of an access gateway based telephone system enhanced with new components enabling high-availability lifeline service;

FIG. 5 is a block diagram that depicts the installation of a new COSU 22 in the central office; and

FIG. 6 is a block diagram of one example of a dual-function telephone instrument useful in ensuring availability of lifeline service in a system that ordinarily provides advanced telephone function.

The components in the figures are not necessarily to scale, emphasis instead being placed upon illustrating the principles of the invention. In the figures, like reference numerals designate corresponding parts throughout the different views.

### DETAILED DESCRIPTION OF THE INVENTION

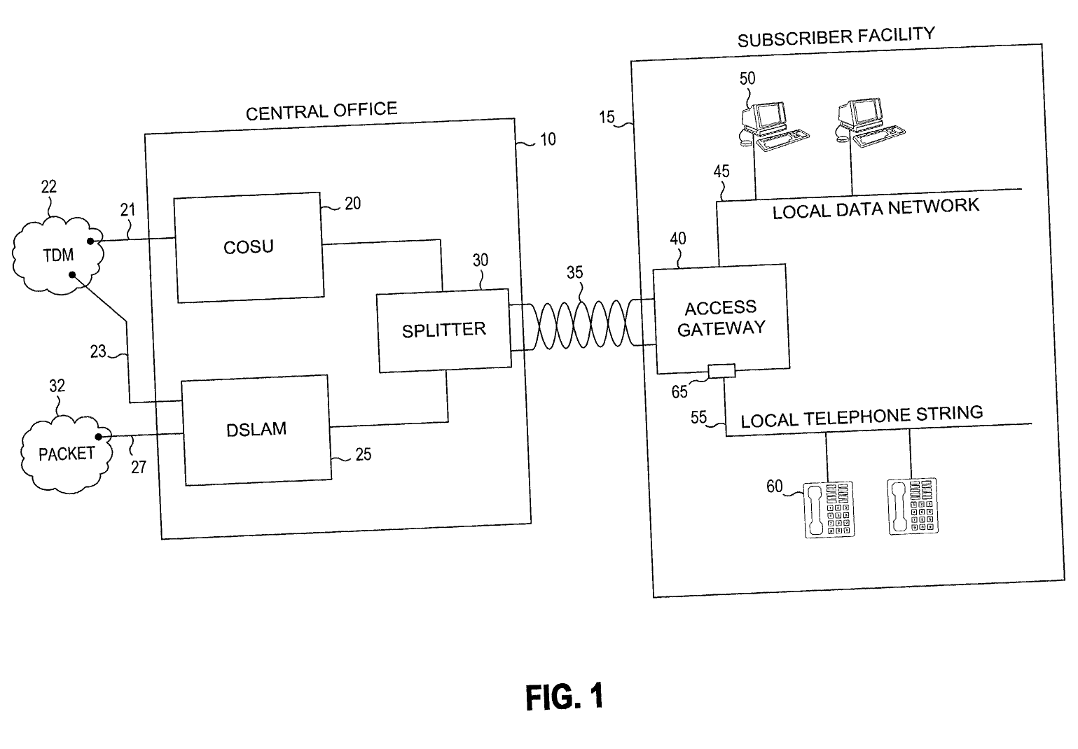

FIG. 1 is a block diagram of a communications system comprising an access gateway that provides data and voice communications to a facility. Such a system typically relies on some form of communications medium 35 that connects a central office 10 to a subscriber facility 15. In most embodiments, the access gateway 40 comprises a central office interface that is used to connect to the communications medium 35. The access gateway 40 further typically comprises an interface to a local data network 45 and a local telephone string 55. The local telephone string is typically connected to the access gateway 40 by way of a local telephone interface 65 that further comprises the gateway 40.

At the central office 10, the communications medium 35 is typically attached to a splitter 30. The splitter is then attached to a central office subscriber unit (COSU) 20 and to a digital subscriber line access multiplexer 25. It should be noted that in a true digitally based communications system, only the digital subscriber line access multiplexer (DSLAM) 25 would be required to provide both data and voice telephony services to the subscriber facility. However, most system installations are the result of evolutionary steps. Where the subscriber facility was originally equipped with tradition PSTN capability, the central office subscriber unit 20 would have been installed to provide that service. In one typical evolutionary step, digital capability to the subscriber facility may have been provided by the subsequent installation of the DSLAM 25 and the splitter 30. Hence, most subscriber facilities connected to a central office today can be supported with either digital communications capability or PSTN service.

In operation, the access gateway 40 serves as a networking switch that enables computing devices or digital appliances 50 attached to a local data network 45 to gain access to external networking resources. Typically, the access gateway 40 comprises a DSL modem. Switching capability comprising the access gateway 40 routes network data from the local data network 45 through to the DSL modem. The DSL modem may then propagate the network data back to the central office 10 by using a carrier signal modulated according to the network data. The DSL carrier signal may then be received by the DSLAM 25 where the network data may be extracted from the carrier signal and propagated to other network resources. This type of data traffic may be routed by the DSLAM to a packet switched network 32 using a packet interface 27 that may comprise the DSLAM. The Internet infrastructure is one possible destination for this type of data.

The access gateway 40 may further comprise a local telephone interface 65. Telephone instruments 60 disposed throughout the subscriber's facility may be attached to a local telephone string 55. The telephone instruments 60 typically impart analog telephony signals onto the local telephone string 55. The access gateway 40 may further comprise a telephony coder/decoder (CODEC). The CODEC converts the analog telephony signals into digital data packets. These digital data packets may then be conveyed to the DSL modem. The DSL modem may then modulate a carrier signal according to the digital data packets and convey the carrier signal back to the DSLAM 25.

The type of telephony service supported by a DSLAM may vary. In some prior art systems, the telephony service supported by the DSLAM may be voice over digital subscriber line (VoDSL). Where VoDSL service is supported, data packets carrying voice telephony from the local telephone string may be routed by the DSLAM to a time division multiplexed network (TDM). These TDM networks are typically used throughout the existing telephone switching infrastructure. In other cases, the DSLAM may only support voice over internet protcol (VoIP). In these cases, the DSLAM may only route the telephony data to a packet switching network. In voice over IP, the DSLAM knows nothing about the telephony packets—they are all IP packets. The voice packets are routed onto the network just as data packets are. These data packets are then routed to a remote termination. There, a VoIP gateway receives the packets from the packet network and forwards them to the telephone infrastructure.

In order to support basic lifeline services, the entire digital communications pathway must be available. This means that the access gateway 40 must have local utility power or it must be supported by an uninterruptible power source. Of course, the access gateway 40 must be functioning properly. This means that the digital communications channel formed between the access gateway 40 and the DSLAM 25 must also be functioning properly. Any failure in the DSLAM 25, the splitter 30, the communications medium 35, or the access gateway 40 will preclude lifeline service. In some situations, the communications channel may be subject to line impairments. These line impairments may comprise ingress noise, echo components, or other factors that may compromise the fidelity of digital communications between the central office 10 and the subscriber facility 15. These, too, can affect the availability of lifeline service.

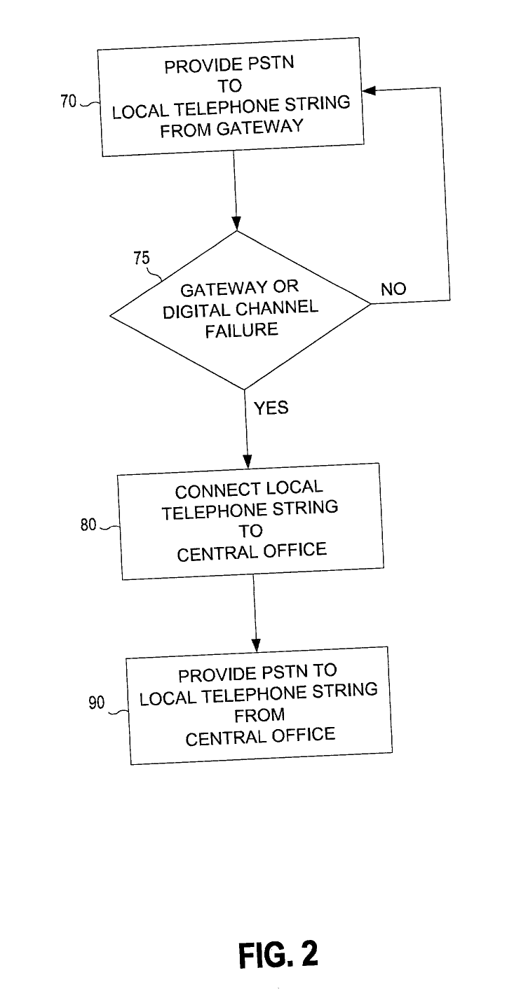

FIG. 2 is a flow diagram that depicts one illustrative method for providing lifeline telephone service to a facility having telephony capabilities provided by an access gateway. According to this illustrative method, facility telephone service is normally supported by the access gateway. To do so, the access gateway must provide PSTN or digital service to the local telephone string (step 70). So long as the gateway has not experienced a failure and the digital communications channel is functioning properly, the gateway may continue to operate and control the local telephone string (step 75).

In the event that the access gateway fails to operate normally, or there is some impairment in the digital communications channel back to the central office, the local telephone string may be connected to the central office (step 80). Once the local telephone string is connected to the central office, the central office may then provide traditional PSTN service to the local telephone string (step 90). The availability of PSTN service on the local telephone string ensures that telephone instruments attached to the string can function normally. Hence, lifeline service can continue unabridged.

In some embodiments of this inventive method, the central office will not normally provide PSTN service. In other embodiments of the inventive method, the central office may continually provide PSTN service to the medium 35 connecting the central office to the subscriber's facility. In these cases, the method described here need not comprise a separate step for causing the central office to enable PSTN service onto the connection.

In some embodiments of this method, the physical connection to the central office may be embodied as a carrier loop. In these cases, the central office may determine when to provide PSTN service to the carrier loop by monitoring the carrier loop for the presence of a health signal. Typically, such a health signal may be injected into the carrier loop by the access gateway so long as the access gateway is operating normally. Alternatively, a health signal may be injected above the physical layer within the protocol between the DSLAM and the customer premises equipment (CPE). In the event that the access gateway experiences a failure, it may stop injecting the health signal into the carrier loop. Once the central office recognizes the lack of the health signal, it may then provide the carrier loop with PSTN service.

In one alternative example embodiment of this method, the central office may determine when to provide PSTN service to the carrier loop by monitoring the activity of a DSLAM that may be servicing the access gateway. In these embodiments of the present method, the central office may provide PSTN service to the carrier loop if the DSLAM becomes inactive. This method may further comprise the steps of causing the central office to stop providing PSTN service to the carrier loop if the DSLAM becomes active and also causing the access gateway to resume PSTN service support. These additional, yet optional steps allow for recovery of digital telephony service in the event of temporal impairments in the digital communications channel.

In some variations of the general method taught here, the central office may determine when to provide PSTN service to the local telephone string 55 at the subscriber's facility by monitoring the health of the access gateway. Upon detecting degradation in the health of the access gateway, the central office may then provide PSTN service. The health of the access gateway may be determined in several ways. One method for determining the health of the access gateway would be to receive failure messages from the access gateway itself These types of failure messages are typically referred to as “last-gasp” or “dying-gasp” messages. Upon detection of a last-gasp message, the central office may provide bias to the telephone string 55 at the subscriber's facility. A second means for detecting an access gateway failure would be to monitor the communications channel for the presence of bias induced by the access gateway as a result of PSTN service it may provide to the local telephone string 55. In the event that the bias is lost, the central office may provide PSTN service to the local telephone string 55.

In some embodiments of a method according to the present invention, the central office may determine when to provide PSTN service to the local telephone string 55 by monitoring the quality of digital communications service between the access gateway and the central office. In these types of methods, the central office may provide PSTN service to the local telephone string 55 whenever the quality of digital service between the access gateway and the central office has degraded to the point where voice telephony can no longer be supported. This may be accomplished by receiving status messages from a DSLAM that may be servicing the access gateway.

In yet a different variation of this illustrative method, the central office may determine when to provide PSTN service to the local telephone string and the subscriber's facility by monitoring the availability of power to operate the access gateway disposed there. One example of such a technique would be to generate a bias or health signal so long as facility power is available. The bias or health signal may be conveyed to the central office using the existing communications medium between the two facilities. The central office would provide PSTN service to the local telephone string 55 whenever the power-available bias or health signal is lost.

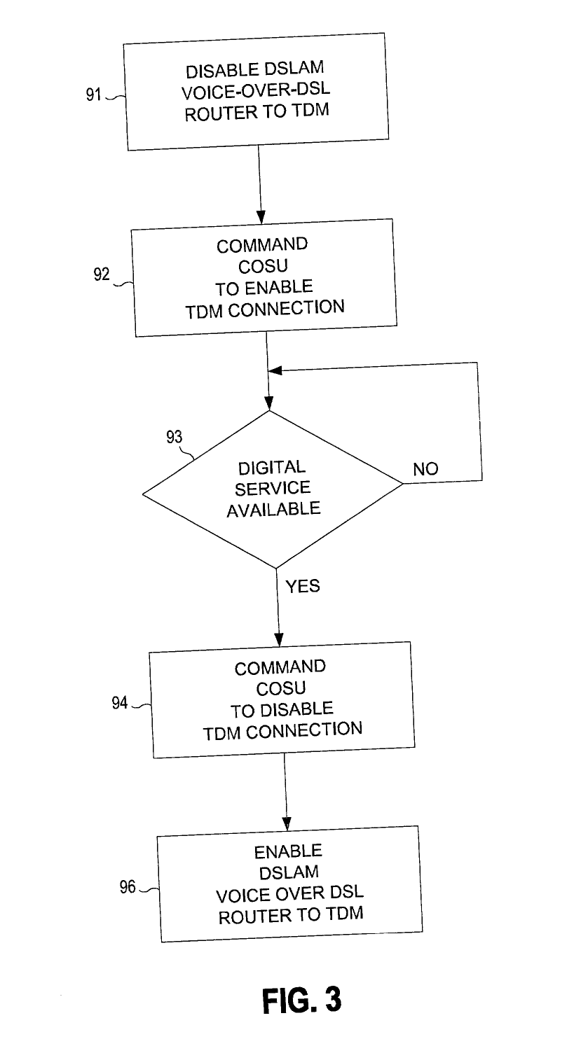

FIG. 3 is a flow diagram that depicts one illustrative method for enabling a central office to provide PSTN service to a subscriber's facility in support of lifeline service according to the present invention. As introduced earlier, some central office equipment may continuously provide PSTN service to the medium connecting the central office to the subscriber's facility. In such cases, the digital telephone service provided by a DSLAM may interfere with the connection a COSU may establish with the telephone infrastructure, i.e. a TDM cloud 22. In order to preclude this interference, the PSTN service provided by the central office may require a different telephone number than that used by the digital service supported by the DSLAM VoDSL connection to the TDM cloud 22. This may prove extremely inconvenient; when a failure in the digital telephone service occurs, incoming phone calls may not be properly completed to the subscriber's facility because of the differing phone numbers used to attach digital and traditional PSTN service to the telephone infrastructure.

By the teachings of the method of the present invention, the central office is capable of determining when it needs to provide PSTN service to the subscriber's facility. When the central office recognizes a need to provide PSTN service, it may reconfigure equipment in the central office to allow PSTN service to respond to the same phone number that was used by the digital telephone service. According to one illustrative method of the present invention, a DSLAM may be disassociated from the TDM cloud 22 when digital service is compromised (step 91). A COSU 20 may then be enabled onto the TDM cloud using the same access number (step 92). So long as digital service remains unavailable, the COSU will continue in this mode (step 93). Upon restoration of digital telephony, the COSU may be disassociated from the TDM cloud (step 94) and the DSLAM may then be re-enabled with the original TDM access configuration (step 96).

Some access gateway telephony systems allow the communications medium from the central office to be connected directly to the local telephone string 55. In these types of systems, the local telephone string 55 is also connected to a local telephone interface further comprising the access gateway. In these embodiments, it may be necessary to disconnect the local telephone string 55 from the access gateway in the event of a failure. Hence, one illustrative method of the present convention provides that connection of the local telephone string to the carrier loop be proceeded by disconnection of the local telephone string from the access gateway's local telephone interface.

In many cases, use of an access gateway to provide voice telephony also enables advanced telephone function throughout the subscriber's facility. In such cases, advanced telephone function may be provided by a specialized digital telephone instruments attached to the local telephone string. Typically, such digital telephone instruments are not capable of supporting traditional, analog telephony. Hence, in one alternative of the general method taught by this invention, lifeline service may require the digital telephone instruments to disassociate themselves from the local telephone string. Once this is accomplished, standard analog telephone instruments may be enabled onto the local telephone string in order to provide analog voice telephony.

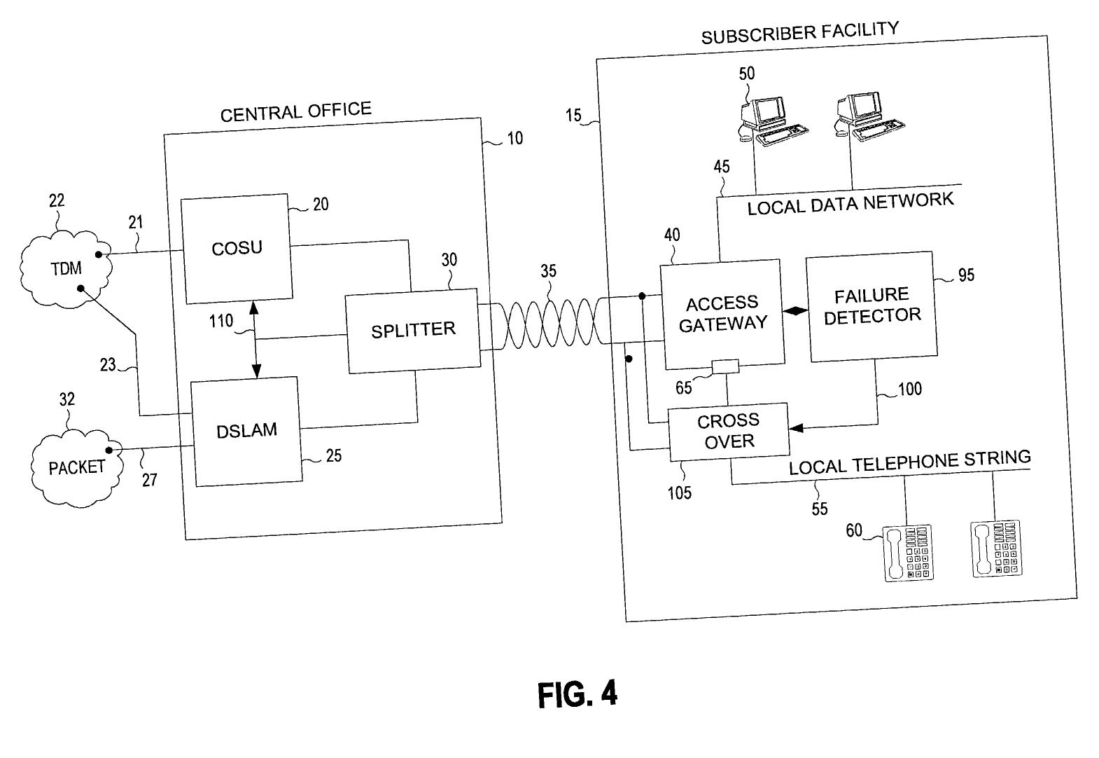

FIG. 4 is a block diagram of an access gateway based telephone system enhanced with new components enabling high-availability lifeline service. According to the present invention, an access gateway based system for providing telephony may comprise a biasing unit capable of providing a bias to a local telephone string 55. Said biasing unit may support either digital or traditional analog telephony and typically provides power and control signaling to the local telephone string 55. In some embodiments, the biasing unit typically comprises one element of an access gateway 40. Such an enhanced system may further comprise a failure detection unit 95 capable of monitoring the operational readiness of the access gateway 40. In some embodiments, the failure detection unit may be incorporated into the access gateway 40.

The purpose of the failure detection unit is to detect when digital service back to the central office, or other digital service provider is no longer available. Once this state has been detected, the local telephone string 55 may be connected to the central office 10. Once the central office is connected to the local telephone string 55, it may then provide PSTN telephone service to the local telephone string 55 so that telephone instruments 60 attached thereto can be used for lifeline service.

The invention further comprises a crossover unit 105. The crossover unit 105 receives a crossover signal 100 that is generated by the failure detector 95. When the crossover signal 100 becomes active, the crossover unit 105 will connect the local telephone string 55 to the communications medium 35 connecting the subscriber facility 15 to the central office 10. In some embodiments, the crossover unit 105 may also disconnect the local telephone string 55 from the local telephone interface 65 comprising the access gateway 40. In one alternative embodiment of the invention, the crossover unit 105 may also connect the local telephone string 55 to the central office 10 when local utility power becomes unavailable. One means of accomplishing this function is through the use of a relay that is wired to connect to local telephone string 55 to the central office when the relay is in a non-engaged, or normal position. This would comprise a true fail-safe embodiment that would return the relay to that position when power is not applied to the relay's coil.

In one example embodiment of a failure detection unit according to the present invention, the failure detection unit may generate a failure message that is dispatched to the central office 10 when a failure is detected in the access gateway 40. Such a failure message may also be dispatched when the loss of utility power becomes imminent. Such a failure message can be thought of as a “last-gasp” message and may be used to instruct the central office to provide PSTN telephone service to the local telephone string located at the subscriber's facility. When such a message is sent. It is typically conveyed to the central office as a digital message using the access gateway 40. However, in order to ensure delivery of the message to the central office in light of a catastrophic failure of the gateway 40 or the digital communications channel servicing the gateway, some embodiments may first convert the message to a simple pulse that can be conveyed directly through the communications medium 35.

According to one example embodiment of the present invention, the crossover unit 105 may propagate the crossover signal 100 to the central office 10. In many cases, the communications medium 35 comprises a carrier loop. Propagation of the crossover signal 100 to the central office 10 may be accomplished by generating a biasing signal indicative of the state of the crossover signal 100 and injecting the bias signal into the carrier loop. In one embodiment, a new splitter 32 disposed at the central office 10 may receive the crossover signal from the communications medium 35 and convey the signal as a “PSTN-Request” command 110 to a new COSU 22. In yet another alternative embodiment of the present invention, the central office 10 may comprise a new COSU 22 that is capable of selectively enabling the provision of PSTN service to the subscriber's facility 15 based upon the “PSTN-Request” command 110.

In yet another alternative embodiment of the present invention, the failure detector 95 may generate a health signal so long as the access gateway 40 does not exhibit any detectable anomaly. In those system embodiments where the communications medium 35 connecting the central office 10 to the subscriber facility 15 is a carrier loop, the health signal may be conveyed to the central office 10 as a bias signal. In one example embodiment, the health signal may be conveyed to the crossover unit 105. The crossover unit 105 may then generate the bias signal and inject the bias signal into the communications medium 35 comprising the carrier loop. The splitter 30 may then receive the bias signal from the carrier loop and convert that to an access gateway health signal locally within the central office 10. This central-office-local health signal may then be conveyed to the new COSU 22. The new COSU 22 may then refrain from providing PSTN service so long as it receives a health signal from the splitter 30.

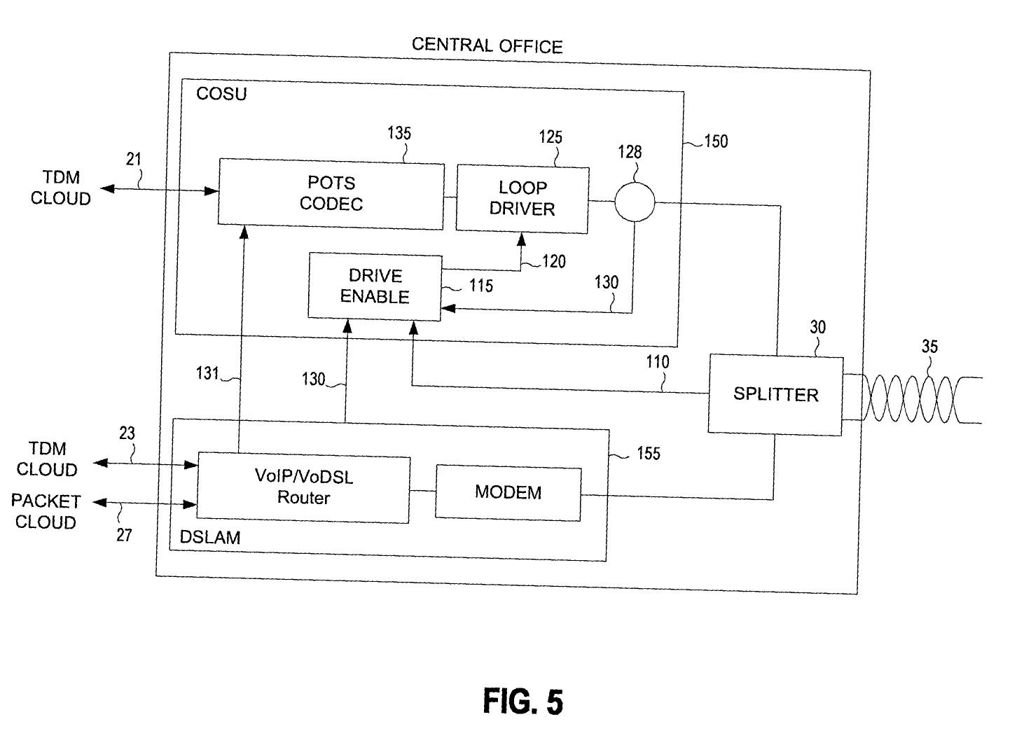

FIG. 5 is a block diagram that depicts the installation of a new COSU 150 in the central office. In this example embodiment, the new COSU 150 may determine when PSTN service needs to be provided to the subscriber's facility by monitoring the activity of the DSLAM. This method does not require the failure detection unit 95 to convey any command nor communicate any message to the central office in order to instruct the central office to begin providing PSTN service to the local telephone string 55.

The present invention comprises a new COSU 150. The new COSU 22 150 also comprise a telephone CODEC that converts analog telephony signals traveling between the central office 10 and the subscriber's facility 15 through the communications medium 35 into digital data compatible with modern telephone switching circuitry. The analog side of the telephone CODEC interfaces with a loop driver 125 that further comprises the new COSU 150. The loop driver 125 receives an enable signal 120 from a drive-enable circuit 115 that also comprises the new COSU 150. When the enable signal is active, the loop driver injects bias into a carrier loop comprising the communications medium 35. Other PSTN related signal and control are also typically imparted onto the communications medium 35.

According to this embodiment of a new COSU 150, the drive-enable circuit 115 receives status messages 130 from a DSLAM 155 that services the subscriber's facility. So long as the status messages 130 indicate the existence of a viable digital interface between the DSLAM 155 and the access gateway 40, the drive-enable circuit 115 will not instruct the loop driver 125 to go active. If the status messages 130 indicate a reduced level of digital service such that digital telephony may not be supported at the subscriber's facility, the drive-enable circuit 115 will command the loop driver 125 to inject bias into the carrier loop. The drive-enable circuit 125 may also command to loop driver 125 to go inactive if digital service between the central office 10 at the subscriber's facility 15 is subsequently restored.

In one alternative example of a new COSU 150, the drive-enable unit 115 may further comprise a crossover signal input that receives the crossover signal 110. In most installations of a system according to the present invention, the splitter 30 generates the crossover signal 110 whenever the splitter 30 detects the presence of the crossover signal in the communications medium 35.

In yet another alternative embodiment of a new COSU 150, the new COSU 150 may further comprise a bias detector 128 disposed on the carrier loop interface that comprises the new COSU 150. In these embodiments, the drive-enable circuit 115 receives a “bias-present” signal 130 from the bias detector 128. In some embodiments of the present invention, the bias signal injected into the communications medium as an indication of the health and/or operation of the access gateway 40 may be directly received by the new COSU 150. Hence, bias detection circuitry need not be disposed in the splitter 30.

This type of bias detector may also be used to detect when a local biasing unit in the access gateway located at the subscriber's facility is providing bias and PSTN signaling to the local telephone string. In these types of system embodiments, the drive-enable circuit 115 may enable the loop driver 125 when the bias detector 128 indicates that no bias is present in the communications medium 35. A suitable interlock may further comprise the drive-enable circuit 115 to ensure that the loop driver 125 is not disabled as a result of central office generated bias and PSTN signaling. In this type of embodiment, the bias detector 128 may further be sensitive to the level of bias present in the communications medium 35. In the case where the local biasing unit, or access gateway resumes normal operation and begins to provide bias to the local telephone string 55, the drive-enable circuit 115 may sense an elevated level of bias in the communications medium 35 and instruct the loop driver 125 to stop injecting bias into the carrier loop.

The present invention may further comprise a new DSLAM 155. The new DSLAM 155 provides a telephone CODEC control signal 131. The telephone CODEC control signal 155 may be activated when the DSLAM is functioning normally and is providing VoDSL digital telephone service to the subscriber's facility. In one illustrative embodiment, the new COSU 150 may disassociate itself from the TDM cloud by disabling its TDM interface 21. In the event that the DSLAM discontinues VoDSL service, the telephone CODEC control signal 155 may become unasserted. This may be used by the new COSU 150 as an indicator that the COSU must enable a TDM telephone connection to the telephone infrastructure.

In some system embodiments, the new COSU 150 and the DSLAM will be programmed to use the same TDM access number so that incoming telephone calls will be recognized on the same phone number. It should be noted that in some embodiments of a new COSU 150, the POTS CODEC 135 may use additional information, such as the state of the drive enable signal 120, to determine if the new COSU 150 needs to provide PSTN service to the subscriber's local telephone string. In the event that this other status information conflicts with the state of the telephone CODEC control signal 131, the POTS CODEC may use an alternative TDM cloud access number to ensure that TDM access will not be interrupted by a faulty DSLAM 155.

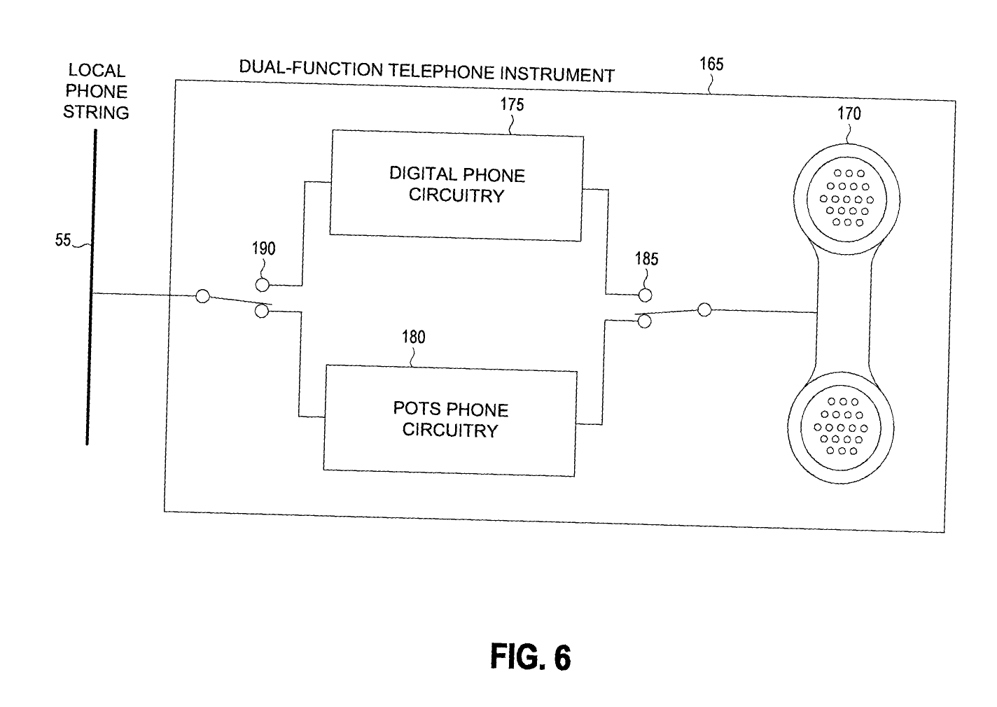

FIG. 6 is a block diagram of one example of a dual-function telephone instrument useful in ensuring availability of lifeline service in a system that ordinarily provides advanced telephone function. In some access gateway based systems, the telephones used in a facility comprise digital instruments. The digital telephone instruments are used to provide advanced telephone function throughout the subscriber's facility. Some of the functions that these digital telephone instruments may provide included placing a calling party on hold, telephone conferencing amongst multiple parties, and intra facility intercom capability. This enumeration is intended to be illustrative and should not be construed as limiting the scope of the present invention. To achieve this level of functionality, the local telephone string 55 typically operates in a digital mode compatible with the digital telephone instruments.

To ensure the availability of lifeline service in the event of a failure in either the access gateway 40, the digital communications channel connecting the access gateway to the central office 10, or within the digital telephone instrument itself, a dual-function telephone instrument may be provided. Hence, the present invention may further comprise a dual-function telephone instrument 165. The dual-function telephone instrument 165 comprises digital phone circuitry 175 and analog telephony circuitry 180. The analog telephony circuitry 180, which is also known as a POTS phone circuit, is capable of communicating over a standard analog telephone string, i.e. PSTN.

The dual-function telephone instrument 165 may further comprise a first isolation unit 185 that selectively enables the telephone handset 170 to either the digital phone circuitry 175 or the POTS phone circuitry 180. The dual function telephone instrument 165 may further comprise a second isolation unit that selectively connects either the digital phone circuitry 175 or the POTS phone circuitry 180 to the local telephone string 55. Each of these isolation units may be switched when digital service is not available at the telephone instrument. One method of determining when the isolation units may be activated relies on monitoring the local telephone string for digital health messages. When the health messages vanish, the isolation units 185 and 190 may cause the POTS phone circuitry to be enabled in deference to the digital function.

What is claimed is:

1. A method for providing life-line service to facilities having voice service through an access gateway connected to a central office by a digital communications channel comprising the steps of:
providing the capability to provide public-switched-telephone-network (PSTN) or digital telephone service to a local telephone string from an access gateway; and
providing the capability to connect the local telephone string to a central office in the event of a failure in the access gateway or impairment of the digital communications channel connecting the access gateway to the central office.

2. The method of claim 1 further comprising the step of providing the capability to cause the central office to start providing PSTN service to the local telephone string in the event of a failure in the access gateway or impairment of the digital communications channel connecting the access gateway to the central office.

3. The method of claim 1 further comprising the step of providing the capability of sending a health signal to the central office so long as the access gateway is operating normally and the digital communications channel connecting the access gateway to the central office has not been impaired.

4. The method of claim 3 wherein the step of providing the capability to send a health signal to the central office comprises the steps of:
providing the capability to inject a health signal into the physical layer of a carrier loop used to provide public-switched-telephone-network service to the local telephone string so long as the access gateway is operating normally and the digital communications channel connecting the access gateway to the central office has not been impaired.

5. The method of claim 3 wherein the step of providing the capability to send a health signal to the central office comprises the step of:
providing the capability to send a health message using a network protocol through a carrier loop used to provide public-switched-telephone-network service to the local telephone string so long as the access gateway is operating normally and the digital communications channel connecting the access gateway to the central office has not been impaired.

6. The method of claim 1 wherein the access gateway is serviced by a digital subscriber line access multiplexer further comprising the step of:
providing the capability of causing the central office to provide PSTN service to the local telephone string if the DSLAM becomes inactive.

7. The method of claim 6 further comprising the steps of:
providing the capability of causing a central office subscriber unit to use the same TDM access number as used by the DSLAM to propagate voice over DSL telephony to a TDM cloud.

8. The method of claim 6 further comprising the steps of:
providing the capability of causing the central office to stop providing PSTN service to the local telephone string if the DSLAM becomes active; and
providing the capability of causing the access gateway to provide PSTN service to the local telephone string if the DSLAM becomes active.

9. The method of claim 2 wherein the step of providing the capability of causing the central office to provide PSTN service comprises the steps of:
providing the capability of monitoring the health of the access gateway; and
providing the capability of causing the central office to provide PSTN service to the local telephone string if the health of the access gateway becomes degraded.

10. The method of claim 2 wherein the step of providing the capability of causing the central office to provide PSTN comprises the steps of:
providing the capability of monitoring the quality of digital service between the access gateway and the central office; and
providing the capability of causing the central office to provide PSTN service to the local telephone string if the quality of digital service between the access gateway and the central office becomes degraded.

11. The method of claim 2 wherein the step of providing the capability of causing the central office to provide PSTN service comprises the steps of:
providing the capability of monitoring the availability of power to operate the access gateway; and
providing the capability of causing the central office to provide PSTN service to the local telephone string if power to operate the access gateway becomes unavailable.

12. The method of claim 1 wherein the local telephone string may be connected to the central office by means of a carrier loop and wherein the step of providing the capability of connecting the local telephone string to the central office comprises the steps of:
providing the capability of disconnecting the local telephone string from an access gateway local telephone interface channel comprising the access gateway; and
providing the capability of connecting the local telephone string to the carrier loop.

13. The method of claim 1 further comprising the steps of:
providing the capability of disassociating the functionality of a full featured phone from the local telephone string; and
providing the capability of enabling analog telephone functionality onto the local plain-old-telephone-service string.

14. A system for providing life-line service to facilities having voice service through an access gateway for connection to a central office through a digital communications channel comprising:
access gateway comprising a local biasing unit that provides public switched telephone network (PSTN) or digital telephone service to a local telephone string;
failure detection unit that monitors the operational status of either the access gateway, the fidelity of the digital communications channel or both and generates a cross-over signal in the event that the access gateway experiences a failure or if the fidelity of the digital communications channel is impaired; and
cross-over connection unit that receives the cross-over signal and connects the local telephone string to a central office if the cross-over signal becomes active.

15. The system of claim 14 further comprising:
central office subscriber unit that receives the cross-over signal and provides PSTN service to the local telephone string if the cross-over signal becomes active.

16. The system of claim 14 wherein the access gateway is serviced by a digital subscriber line access multiplexer and wherein the central office subscriber unit monitors the fidelity of the digital communications channel by monitoring the activity of the digital subscriber line access multiplexer and provides PSTN service to the local telephone string if the digital subscriber line access multiplexer becomes inactive.

17. The system of claim 16 wherein the central office subscriber unit uses the same access number to connect to a telephone infrastructure when the digital subscriber line access multiplexer fails to provide voice over digital subscriber line digital telephone service to the access gateway.

18. The system of claim 16 wherein the central office subscriber unit further ceases to provide PSTN service to the local telephone string if the digital subscriber line access multiplexer becomes active.

19. The system of claim 14 wherein the digital communications channel between the access gateway and the central office is carried by a carrier loop and wherein the central office subscriber unit provides PSTN service to the local telephone string by providing PSTN service to the carrier loop.

20. The system of claim 14 wherein the digital communications channel between the access gateway and the central office is carried by a carrier loop and wherein the fault detector conveys the cross-over signal to the central office subscriber unit by injecting the signal into the carrier loop.

21. The system of claim 14 wherein the failure detection unit further monitors the availability of local facility power and generates a cross-over signal if local facility power becomes unavailable.

22. The system of claim 14 wherein cross-over connection unit connects the local telephone string to the central office if local facility power becomes unavailable.

23. The system of claim 14 wherein cross-over connection unit comprises a relay wired to connect the local telephone string to the central office while the relay's coil in not energized.

24. The system of claim 14 further comprising a dual-function telephone instrument that comprises:
digital telephone instrument;
analog telephone instrument; and
isolation unit that receives the cross-over signal and detaches the digital telephone instrument from the local telephone string and attaches the analog telephone instrument to the local telephone string if the cross-over signal is active.

25. The system of claim 14 further comprising a dual-function telephone instrument that comprises:
digital telephone instrument;
analog telephone instrument; and
isolation unit that detaches the digital telephone instrument from the local telephone string and attaches the analog telephone instrument to the local telephone string if local facility power becomes unavailable.

26. A system for providing life-line service to facilities having voice service through an access gateway comprising:
access gateway comprising local biasing unit that provides PSTN or digital telephone service to a local telephone service string;
failure detection unit that monitors the operational status of the access gateway and generates a health signal so long as the access gateway has not experienced a failure; and
cross-over connection unit that receives the health signal and connects the local telephone string to a central office if the health signal becomes inactive.

27. The system of claim 26 further comprising:
central office subscriber unit that provides PSTN service to the local telephone string if the health signal becomes inactive.

28. The system of claim 26 wherein the access gateway is connected to a central office using a carrier loop and wherein the failure detection unit conveys the health signal to the central office subscriber unit as a bias signal injected into the carrier loop.
